(19) United States
(12) Patent Application Publication
(10) Pub. No.: US 2026/0145616 A1
(43) Pub. Date: May 28, 2026

(54) CONSOLE BOX

(71) Applicant: TOYODA GOSEI CO., LTD., Kiyosu-shi (JP)

(72) Inventor: Kohei YOSHIDA, Kiyosu-shi (JP)

(21) Appl. No.: 19/388,760

(22) Filed: Nov. 13, 2025

(30) Foreign Application Priority Data
Nov. 28, 2024 (JP) 2024-206979

(51) Int. Cl. B60R 7/04

(52) U.S. Cl. CPC B60R 7/04

(57) ABSTRACT

A console box includes a box body and a cover. One of the box body and the cover includes a protruding wall. The other one of the box body and the cover includes a restricting portion that restricts relative movement of the protruding wall in a thickness direction of the protruding wall. The restricting portion includes a contact portion that comes into contact with the protruding wall and a tab that engages with a receiving portion located on the one of the box body and the cover in a state in which the protruding wall is in contact with the restricting portion. The receiving portion is configured to restrict relative movement of the restricting portion in a protruding direction of the protruding wall and an intersecting direction when the tab engages with the receiving portion. The intersecting direction intersects the thickness direction and the protruding direction.

### CROSS-REFERENCE TO RELATED APPLICATIONS

This application is based upon and claims the benefit of priority from Japanese Patent Application No. 2024-206979, filed on November 28, 2024, the entire contents of which are incorporated herein by reference.

### BACKGROUND

### 1. Field

The present disclosure relates to a console box.

### 2. Description of Related Art

JP2007-137391A discloses a center console disposed between the driver’s seat and the passenger seat of a vehicle. The center console includes a console body that has two side plates and two outer side panels that respectively cover the two side plates from outside. The two side plates are spaced apart from each other in the left-right direction, and extend in the front-rear direction of the vehicle. The two side plates each include plate-side screw holes, coupling bosses, and a panel coupling part. The plate-side screw holes are arranged at intervals in the front-rear direction on the front side of the side plate. The coupling bosses are arranged at intervals in the front-rear direction on the rear side of the side plate. The panel coupling part is located at the rear end of the side plate.

Each of the two side plates further includes flat portions extending across the side plates. The flat portions are spaced apart from each other in the front-rear direction. Each flat portion includes an insertion opening that extends through the flat portion in the up-down direction.

The inner surface of each of the two outer side panels includes fitting portions. The fitting portions are located to correspond to the insertion openings of the side plate. Each fitting portion includes an insertion portion that extends in the up-down direction and is inserted into the corresponding insertion opening, and a bent portion that extends downward, bending from the insertion portion.

The two outer side panels each include upper through-holes and a rear through-hole. The upper through-holes are located to correspond to the coupling bosses. The rear through-hole is located to correspond to the panel coupling part. Further, the outer side panel includes panel coupling parts at positions corresponding to the plate-side screw holes.

In such a console box, the outer side panel is assembled according to, for example, the following procedure.

First, to couple the outer side panel to the console body, the insertion portions of the fitting portions are respectively inserted into the insertion openings. Accordingly, the outer side panel is positioned in the front-rear direction.

Then, screws, which serve as fasteners, are inserted into the upper through-holes and the rear through-hole and fastened to the coupling bosses and the panel coupling part. Further, a screw is inserted into the through-hole of the panel coupling part and fastened to the plate-side screw hole. Thus, the outer side panel is firmly coupled to the console body.

In such a center console, the positioning of the outer side panel and the fixing of the outer side panel using the fasteners are performed separately at different locations. Thus, even when the outer side panel is fixed to the console body using fasteners, looseness may occur at the locations where the outer side panel are positioned using the fitting portions and the insertion openings. The looseness may reduce the rigidity of the outer side panel.

### SUMMARY

This Summary is provided to introduce a selection of concepts in a simplified form that are further described below in the Detailed Description. This Summary is not intended to identify key characteristics or essential characteristics of the claimed subject matter, nor is it intended to be used as an aid in determining the scope of the claimed subject matter.

A console box according to an aspect of the present disclosure includes a box body and a cover coupled to the box body to cover part of the box body from outside. One of the box body and the cover includes a protruding wall that protrudes toward an other one of the box body and the cover. The other one of the box body and the cover includes a restricting portion that restricts relative movement of the protruding wall in a thickness direction of the protruding wall by coming into contact with the protruding wall from opposite sides of the protruding wall in the thickness direction. The restricting portion includes a contact portion that protrudes toward the one of the box body and the cover and comes into contact with the protruding wall and a tab that protrudes from the contact portion toward one side in the thickness direction. The tab engages with a receiving portion in a state in which the protruding wall is in contact with the restricting portion. The receiving portion is located on the one of the box body and the cover. The receiving portion is configured to restrict relative movement of the restricting portion in a protruding direction of the protruding wall and an intersecting direction when the tab engages with the receiving portion. The intersecting direction intersects the thickness direction and the protruding direction.

Other features and aspects will be apparent from the following detailed description, the drawings, and the claims.

### BRIEF DESCRIPTION OF THE DRAWINGS

FIG. 1 is a partial cross-sectional view showing a console box according to an embodiment.

FIG. 2 is an enlarged view of a main part of the console box shown in FIG. 1, and is a cross-sectional view showing the box body and the side panel in a separated state.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

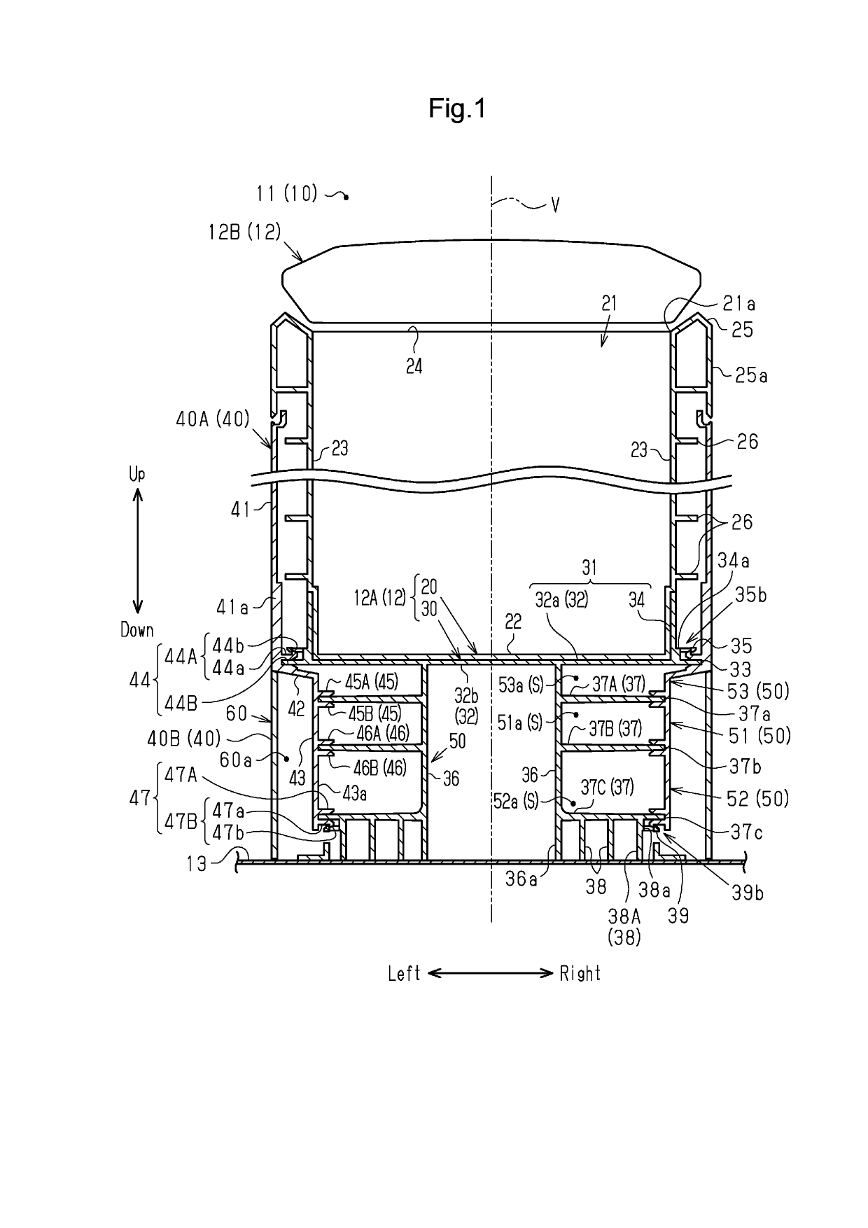

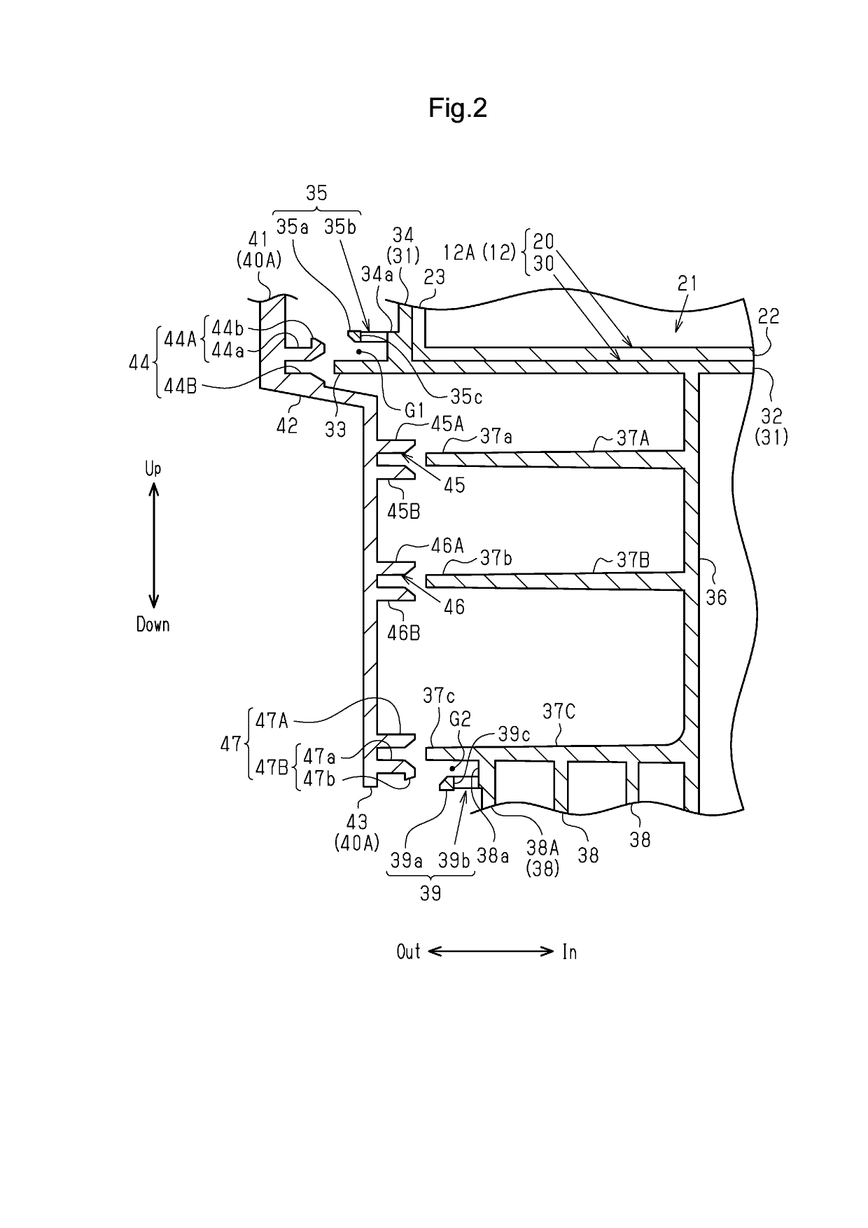

A console box according to an embodiment will now be described with reference to FIGS. 1 and 2. In the present embodiment, the present disclosure is implemented as a console box 12 disposed between the driver’s seat and the front passenger seat in a passenger compartment 11 of a vehicle 10.

Hereinafter, the front-rear direction of the vehicle 10 will be referred to as the front-rear direction. The front side and the rear side in the front-rear direction are simply referred to as the front side and the rear side, respectively. The width direction of the vehicle 10 is referred to as the vehicle width direction. The right side and the left side in the vehicle width direction when viewed from the rear toward the front of the vehicle 10 are simply referred to as the right side and the left side, respectively. The up-down direction of the vehicle 10 when the vehicle 10 is positioned on a horizontal plane is referred to as the up-down direction. The upper side and the lower side in the up-down direction are simply referred to as the upper side and the lower side, respectively.

As shown in FIG. 1, the console box 12 includes a box body 12A, a lid 12B, and two covers 40.

Each component will now be described. The console box 12 of the present embodiment extends through its central portion in the vehicle width direction. The console box 12 is shaped to be symmetrical with respect to a virtual plane V extending in the front-rear direction and the up-down direction. Thus, the components of the console box 12 on one of the right and left sides will be described hereinafter, and those on the other side may not be described.

### Box Body

As shown in FIG. 1, the box body 12A forms the frame of the console box 12, and is fixed to a vehicle body floor 13 using fasteners (e.g., bolts and nuts) at positions (not shown). The box body 12A includes a body upper portion 20 and a body lower portion 30, which respectively form the upper portion and the lower portion of the box body 12A.

### Body Upper Portion

As shown in FIG. 1, the body upper portion 20 is box-shaped, and includes a recess 21 that accommodates an article. The recess 21 includes an opening 21a that opens upward. In the present embodiment, the opening 21a is rectangular, being longer in the front-rear direction than in the vehicle width direction. A lid 12B for opening and closing the opening 21a is coupled to the body upper portion 20. FIG. 1 illustrates the console box 12, with the opening 21a closed by the lid 12B.

The body upper portion 20 includes a bottom wall 22, two first side walls 23, and two second side walls 24. The bottom wall 22 defines the bottom surface of the recess 21. The bottom wall 22 is plate-shaped with a thickness in the up-down direction, and extends in the front-rear direction rather than in the vehicle width direction. The two first side walls 23 extend upward from the opposite ends of the bottom wall 22 in the vehicle width direction. The upper end of each first side wall 23 forms a long side portion of the opening 21a. The two second side walls 24 extend upward from the opposite ends of the bottom wall 22 in the front-rear direction. The upper end of each second side wall 24 forms a short side portion of the opening 21a. FIG. 1 illustrates only one of the two second side walls 24.

In the vehicle width direction, the direction or side approaching the central portion of the console box 12 is referred to as, for example, “inner,” “inward,” or “inside,” and the direction or side extending away from the central portion is referred to as, for example, “outer,” “outward,” or “outside.”

The two first side walls 23 each include an opening edge 25 and reinforcing ribs 26. The opening edge 25 is the edge of the opening 21a in the vehicle width direction. The opening edge 25 includes an outer wall 25a facing the first side wall 23 on the outer side of the first side wall 23. The outer wall 25a defines part of a design surface of the console box 12.

The reinforcing ribs 26 protrude outward from the first side wall 23. The reinforcing ribs 26 are spaced apart from each other in the up-down direction and extend in the front-rear direction.

In the present embodiment, the bottom wall 22, the two first side walls 23, the two second side walls 24, the two opening edges 25, and the reinforcing ribs 26 are integrally molded from a resin material to form the body upper portion 20.

### Body Lower Portion

As shown in FIG. 1, the body lower portion 30 includes a support 31, two second vertical walls 36, and multiple horizontal walls 37.

The support 31 supports the body upper portion 20 in an orientation in which the opening 21a faces upward. The support 31 includes a coupling wall 32 and two first vertical walls 34. The coupling wall 32 is plate-shaped with a thickness in the up-down direction, and extends in the front-rear direction rather than in the vehicle width direction. The bottom wall 22 of the body upper portion 20 is placed on an upper surface 32a of the coupling wall 32. In this state, the bottom wall 22 is fastened to the coupling wall 32 using fasteners such as bolts and nuts (not shown), so that the body upper portion 20 is coupled to the body lower portion 30. Opposite ends 33 of the coupling wall 32 in the vehicle width direction protrude outward from the first side wall 23. The two first vertical walls 34 extend upward from the coupling wall 32. The two first vertical walls 34 are located outward of the two first side walls 23 and inward of the ends 33 in the vehicle width direction.

In the present embodiment, the body upper portion 20 and the support 31 correspond to a storage, the bottom wall 22 and the coupling wall 32 correspond to a bottom wall, and the end 33 corresponds to a protruding wall. Accordingly, the up-down direction in the present embodiment corresponds to a thickness direction, and the upper side in the present embodiment corresponds to one side in the thickness direction. Further, the vehicle width direction and the front-rear direction in the present embodiment correspond to a protruding direction and an intersecting direction.

As shown in FIGS. 1 and 2, each first vertical wall 34 includes a thickened portion 34a and first receiving portions 35. The thickened portion 34a is formed by outwardly bulging the lower end of the first vertical wall 34 so as to have a thickness in the vehicle width direction greater than that of other portions of the first vertical wall 34 in the up-down direction.

As shown in FIG. 2, the first receiving portion 35 includes an elastic projection 35a protruding outward from the thickened portion 34a. The elastic projection 35a is adjacent to the end 33 with a gap G1 in the up-down direction. In the present embodiment, the elastic projection 35a is disposed above the end 33. The elastic projection 35a includes a through-hole 35b extending therethrough in the up-down direction. The elastic projection 35a is configured to allow insertion of an upper restricting portion 44A, which will be described below, into the gap G1 in the vehicle width direction toward the upper side, that is, in a direction away from the end 33 in the up-down direction. In the present embodiment, multiple first receiving portions 35 are arranged at intervals in the front-rear direction on the thickened portion 34a of the first vertical wall 34.

As shown in FIG. 1, the two second vertical walls 36 protrude downward from a lower surface 32b of the coupling wall 32. The two second vertical walls 36 are spaced apart from each other in the vehicle width direction and extend in the front-rear direction. Multiple horizontal walls 37 protrude outward from each of the two second vertical walls 36. Specifically, three horizontal walls 37 protrude from each second vertical wall 36. The three horizontal walls 37 are arranged at intervals downward of the coupling wall 32 and extend in the front-rear direction. Hereinafter, the three horizontal walls 37 will be referred to as a horizontal wall 37A, a horizontal wall 37B, and a horizontal wall 37C in order from the top. In the present embodiment, the horizontal walls 37A, 37B, and 37C respectively include outer ends 37a, 37b, and 37c that are located inward of the reinforcing ribs 26 and the ends 33. In the present embodiment, the end 37c of the horizontal wall 37C corresponds to the protruding wall. The horizontal wall 37C includes multiple (three in the present embodiment) legs 38. The legs 38 protrude downward from the lower surface of the horizontal wall 37C. The legs 38 are spaced apart from each other outwardly from a lower end 36a of the second vertical wall 36, and extend in the front-rear direction.

As shown in FIGS. 1 and 2, the outermost one of the legs 38 is an outer leg 38A that includes a thickened portion 38a and second receiving portions 39. The thickened portion 38a is formed by outwardly bulging the upper end of the outer leg 38A so as to have a thickness in the vehicle width direction greater than that of other portions of the outer leg 38A in the up-down direction.

As shown in FIG. 2, the second receiving portion 39 includes an elastic projection 39a protruding outward from the thickened portion 38a. The elastic projection 39a is adjacent to the horizontal wall 37C with a gap G2 in the up-down direction. In the present embodiment, the elastic projection 39a is disposed below the horizontal wall 37C. The elastic projection 39a includes a through-hole 39b extending therethrough in the up-down direction. The elastic projection 39a is configured to allow insertion of a lower restricting portion 47B, which will be described below, into the gap G2 in the vehicle width direction toward the lower side, that is, in a direction away from the horizontal wall 37C in the up-down direction. In the present embodiment, multiple second receiving portions 39 are arranged at intervals in the front-rear direction on the thickened portion 38a of the outer leg 38A.

In the present embodiment, the support 31, the two second vertical walls 36, the horizontal walls 37, and the legs 38 are integrally molded from a resin material to form the body lower portion 30.

### Cover

As shown in FIG. 1, the two covers 40 include two side panels 40A and two outer side panels 40B.

The two side panels 40A are coupled to the box body 12A to cover the left and right sides of the box body 12A from outside. The side panels 40A each include an upper side panel 41, a lower side panel 43, and a connecting wall 42 that connects these two panels to each other. The upper side panel 41 is plate-shaped with a thickness in the vehicle width direction, and extends in the front-rear direction rather than in the up-down direction. The upper side panel 41 covers the first side wall 23 and the first vertical wall 34 from outside. The outer surface of the upper side panel 41 is flush with outer surface of the outer wall 25a, and forms part of the design surface of the console box 12 together with the outer surface of the outer wall 25a. The upper end of the upper side panel 41 is engaged with the opening edge 25 by engagement tabs (not shown). The lower end of the upper side panel 41 includes a thickened portion 41a. The thickened portion 41a is formed by inwardly bulging the lower end of the upper side panel 41 so as to have a thickness in the vehicle width direction greater than that of other portions of the upper side panel 41 in the up-down direction.

The connecting wall 42 connects the lower end of the upper side panel 41 (i.e., the thickened portion 41a) to the upper end of the lower side panel 43. The connecting wall 42 is inclined such that it is positioned lower toward the inside.

The lower side panel 43 is plate-shaped with a thickness in the vehicle width direction, and extends in the front-rear direction rather than in the up-down direction. The lower side panel 43 covers the second vertical wall 36 from outside. The lower side panel 43 is located inward of the upper side panel 41.

As shown in FIG. 1, each outer side panel 40B is coupled to the corresponding lower side panel 43 from outside by a coupling portion (not shown). The outer side panel 40B is plate-shaped with a thickness in the vehicle width direction, and extends in the front-rear direction rather than in the up-down direction. The outer surface of the outer side panel 40B is flush with outer surface of the upper side panel 41, and forms part of the design surface of the console box 12 together with the outer surface of the upper side panel 41.

### Restricting Portion

As shown in FIGS. 1 and 2, the side panel 40A includes a first restricting portion 44, second restricting portions 45 and 46, and a third restricting portion 47.

The first restricting portion 44 includes the upper restricting portion 44A and a lower restricting portion 44B. The upper restricting portion 44A includes a contact portion 44a protruding inward from the thickened portion 41a, and a tab 44b protruding upward from the tip of the contact portion 44a. The tab 44b is engaged with a wall surface 35c of the through-hole 35b, with the upper restricting portion 44A inserted into the gap G1. The tab 44b is restricted from moving outward by coming into contact with the wall surface 35c from inside. Further, the tab 44b is restricted from moving in the front-rear direction by coming into contact with the wall surface 35c on the front side and the rear side. In other words, the first receiving portion 35 is configured to restrict relative movement of the upper restricting portion 44A and thus restrict relative movement of the first restricting portion 44 in the front-rear direction and on the outer side in the vehicle width direction when the tab 44b is engaged with the through-hole 35b. In the present embodiment, the thickened portion 41a includes multiple upper restricting portions 44A that are spaced apart from each other in the front-rear direction. The upper restricting portion 44A are respectively located in correspondence with the first receiving portions 35 in the vehicle width direction. The lower restricting portion 44B is formed by inwardly bulging the upper end of the connecting wall 42 with a gap from the contact portion 44a in the up-down direction (see FIG. 2). The lower restricting portion 44B extends over the entire connecting wall 42 in the front-rear direction. The end 33 is inserted into the space between the two restricting portions 44A and 44B (see FIG. 1). In this state, the projecting end of the end 33 is in contact with the thickened portion 41a. Further, the contact portion 44a of the upper restricting portion 44A is in contact with the end 33 from above. Furthermore, the lower restricting portion 44B is in contact with the end 33 from below.

As shown in FIGS. 1 and 2, the second restricting portion 45 includes an upper restricting portion 45A and a lower restricting portion 45B that protrude inward from the lower side panel 43. The two restricting portions 45A and 45B are protrusions spaced apart from each other in the up-down direction and continuously extending in the front-rear direction (see FIG. 2). The end 37a of the horizontal wall 37A is inserted into the space between the two restricting portions 45A and 45B (see FIG. 1). In this state, the projecting end of the horizontal wall 37A is in contact with the inner surface of the lower side panel 43. Further, the two restricting portions 45A and 45B are in contact with the horizontal wall 37A from above and below, respectively.

The second restricting portion 46 includes an upper restricting portion 46A and a lower restricting portion 46B that protrude inward from the lower side panel 43. The two restricting portions 46A and 46B are protrusions spaced apart from each other in the up-down direction and continuously extending in the front-rear direction (see FIG. 2). The end 37b of the horizontal wall 37B is inserted into the space between the two restricting portions 46A and 46B (see FIG. 1). In this state, the projecting end of the horizontal wall 37B is in contact with the inner surface of the lower side panel 43. Further, the two restricting portions 46A and 46B are in contact with the horizontal wall 37B from above and below, respectively.

As shown in FIGS. 1 and 2, the third restricting portion 47 includes the upper restricting portion 47A and the lower restricting portion 47B. The upper restricting portion 47A is a protrusion that protrudes inward from a lower end 43a of the lower side panel 43 and continuously extends in the front-rear direction. The lower restricting portion 47B includes a contact portion 47a protruding inward from the lower end 43a of the lower side panel 43, and a tab 47b protruding downward from the tip of the contact portion 47a. The contact portion 47a is adjacent to the upper restricting portion 47A with a gap in the up- down direction (see FIG. 2). In the present embodiment, the lower restricting portion 47B is located below the upper restricting portion 47A. The end 37c of the horizontal wall 37C is inserted into the space between the two restricting portions 47A and 47B (see FIG. 1). In this state, the projecting end of the horizontal wall 37C is in contact with the lower side panel 43. Further, the upper restricting portion 47A is in contact with the end 37c of the horizontal wall 37C from above. Furthermore, the contact portion 47a of the lower restricting portion 47B is in contact with the end 37c of the horizontal wall 37C from below. The tab 47b is engaged with a wall surface 39c of the through-hole 39b, with the lower restricting portion 47B inserted into the gap G2. The tab 47b is restricted from moving outward by coming into contact with the wall surface 39c from inside. Further, the tab 47b is restricted from moving in the front-rear direction by coming into contact with the wall surface 39c on the front side and the rear side. In other words, the second receiving portion 39 is configured to restrict relative movement of the lower restricting portion 47B and thus restrict relative movement of the third restricting portion 47 in the front-rear direction and on the outer side in the vehicle width direction when the tab 47b engages with the through-hole 39b. In the present embodiment, the lower end 43a of the lower side panel 43 includes multiple lower restricting portions 47B that are spaced apart from each other in the front-rear direction. The lower restricting portions 47B are respectively located in correspondence with the second receiving portions 39 in the vehicle width direction.

In the present embodiment, the upper side panel 41, the connecting wall 42, the lower side panel 43, and the restricting portions 44, 45, 46, and 47 are integrally molded from a resin material to form the side panel 40A.

### Duct, and Outer Anti-Condensation Portion

As shown in FIG. 1, the console box 12 includes two ducts 50 and two outer anti-condensation portions 60.

Each duct 50 includes a space S that is defined by the coupling wall 32, the second vertical wall 36, the horizontal wall 37C, and the cover 40. The two ducts 50 are spaced apart from each other in the vehicle width direction. Each duct 50 is divided into an upper duct 51, a lower duct 52, and an anti-condensation portion 53 by the horizontal walls 37A and 37B. The upper duct 51 includes a passage 51a through which conditioned air supplied from an air-conditioning device (not shown), which is mounted in the vehicle 10, flows. The passage 51a is a space defined by the horizontal walls 37A and 37B, the second vertical wall 36, and the lower side panel 43. The downstream end of the upper duct 51 in the flow direction of conditioned air is connected to, for example, an air outlet (not shown) that blows out the conditioned air toward the face of an occupant on the rear seat. The lower duct 52 includes a passage 52a through which conditioned air supplied from an air-conditioning device (not shown) flows. The passage 52a is a space defined by the horizontal walls 37B and 37C, the second vertical wall 36, and the lower side panel 43. For example, the passage 52a is supplied with conditioned air that is adjusted to be different in temperature or air volume from the conditioned air flowing through the passage 51a. The downstream end of the lower duct 52 in the flow direction of conditioned air is connected to, for example, an air outlet (not shown) that blows out the conditioned air toward a footwell of an occupant on the rear seat. The anti-condensation portion 53 includes a cavity 53a defined by the coupling wall 32, the horizontal wall 37A, the second vertical wall 36, and the lower side panel 43. The anti-condensation portion 53 is configured to block heat transfer from the upper duct 51 to the bottom wall 22 by means of the cavity 53a. Thus, when cooled conditioned air flows through the passage 51a, the coupling wall 32 and the bottom wall 22 are cooled, thereby limiting the occurrence of condensation on the bottom wall 22.

As shown in FIG. 1, the outer anti-condensation portion 60 includes a cavity 60a defined by the connecting wall 42, the lower side panel 43, and the outer side panel 40B. The outer anti-condensation portion 60 is configured to block heat transfer from the upper duct 51 and the lower duct 52 to the outer side panel 40B by means of the cavity 60a. Thus, when cooled conditioned air flows through the passages 51a and 52a, the outer side panel 40B is cooled, thereby limiting the occurrence of condensation on the outer side panel 40B.

### Operation of the Present Embodiment

First, to couple the side panel 40A of the cover 40 to the box body 12A, the end 33 of the coupling wall 32, which is located on the box body 12A, and the ends 37a, 37b, 37c of the horizontal wall 37 are respectively inserted into the restricting portions 44, 45, 46, 47, which are located on the side panel 40A. In this state, the end 33 is held at multiple positions in the front-rear direction from above and below by multiple upper restricting portions 44A and multiple lower restricting portions 44B. That is, the restricting portions 44A and 44B are in contact with the end 33 from above and below. In addition, the ends 37a and 37b are sandwiched from above and below by the upper restricting portions 45A and 46A and the lower restricting portions 45B and 46B. That is, the restricting portions 45A and 45B are brought into contact with the end 37a from above and below, and the restricting portions 46A and 46B are brought into contact with the end 37b from above and below. Further, the end 37c is held at multiple positions in the front-rear direction from above and below by the upper restricting portion 47A and multiple lower restricting portions 47B. That is, the restricting portions 47A and 47B are in contact with the end 37c from above and below.

Thus, the ends 33, 37a, 37b, and 37c are restricted from moving relative to the restricting portions 44, 45, 46, and 47 in the up-down direction. In other words, the side panel 40A is restricted from moving in the up-down direction relative to the box body 12A. As a result, the side panel 40A is positioned in the up-down direction.

In the console box 12 of the present embodiment, in a state in which the end 33 is in contact with the first restricting portion 44, the tabs 44b protruding from the contact portions 44a of the upper restricting portions 44A are engaged with the through-holes 35b of the first receiving portions 35. Each tab 44b is restricted from moving outward by coming into contact with the wall surface 35c from inside. Further, the tab 44b is restricted from moving in the front-rear direction by coming into contact with the wall surface 35c on the front side and the rear side. Thus, when the side panel 40A is positioned as described above, the upper restricting portion 44A of the first restricting portion 44 is restricted from moving relative to the first receiving portion 35 on the outer side in the vehicle width direction and in the front-rear direction.

In the console box 12 of the present embodiment, in a state in which the end 37c is in contact with the third restricting portion 47, the tabs 47b protruding from the contact portions 47a of the lower restricting portions 47B are engaged with the through-holes 39b of the second receiving portions 39. Each tab 47b is restricted from moving outward by coming into contact with the wall surface 39c from inside. Further, the tab 47b is restricted from moving in the front-rear direction by coming into contact with the wall surface 39c on the front side and the rear side. Thus, when the side panel 40A is positioned as described above, the lower restricting portion 47B of the third restricting portion 47 is restricted from moving relative to the second receiving portion 39 on the outer side in the vehicle width direction and in the front-rear direction. The above-described configuration limits looseness of the side panel 40A at a portion where the side panel 40A is positioned by means of the end 33 and 37c and the restricting portions 44 and 47.

### Advantages of the Present Embodiment

(1) The box body 12A includes the end 33 of the coupling wall 32 as the protruding wall protruding toward the side panel 40A of the cover 40. The side panel 40A includes the first restricting portion 44, which restricts relative movement of the end 33 in the up-down direction by coming into contact with the end 33 from above and below. Multiple upper restricting portions 44A of the first restricting portion 44 each include the contact portion 44a, which protrudes inward and comes into contact with the end 33 from above. Further, the upper restricting portions 44A respectively include the tabs 44b. The tabs 44b respectively protrude upward from the contact portions 44a and engage with the first receiving portions 35, which are provided in the first vertical wall 34, in a state in which the ends 33 are in contact with the respective first restricting portions 44. Each first receiving portion 35 is configured to restrict relative movement of the upper restricting portion 44A in the front-rear direction and on the outer side in the vehicle width direction when the tab 44b is engaged with the through-hole 35b.

Such a configuration produces the above-described advantage. This limits a decrease in the rigidity of the side panel 40A due to looseness.

(2) The box body 12A further includes the end 37c of the horizontal wall 37C as the protruding wall protruding toward the side panel 40A of the cover 40. The lower side panel 43 of the side panel 40A includes the third restricting portion 47, which restricts relative movement of the end 37c in the up-down direction by coming into contact with the end 37c from above and below. Each lower restricting portion 47B of the third restricting portion 47 includes the contact portion 47a, which protrudes inward and comes into contact with the end 37c from below. Further, each third restricting portion 47 includes the corresponding tab 47b. The tab 47b protrudes upward from the contact portion 47a and engages with the second receiving portion 39, which is provided in the outer leg 38A, in a state in which the end 37c is in contact with the third restricting portion 47. Each second receiving portion 39 is configured to restrict relative movement of the lower restricting portion 47B in the front-rear direction and on the outer side in the vehicle width direction when the tab 47b is engaged with the through-hole 39b.

Such a configuration produces the same above-described advantage as the above advantage (1).

With the above-described configuration, the side panel 40A is fixed in association with the positioning of the side panel 40A. This allows the side panel 40A to be assembled more simply than a conventional console box in which the side panel is separately fixed at a position away from a positioning portion using, for example, a screw.

(3) The receiving portions 35 and 39 respectively include the elastic projections 35a and 39a, which protrude outward at positions adjacent to the ends 33 and 37c with the gaps G1 and G2 in the up-down direction. The elastic projections 35a and 39a are configured to allow insertion of the contact portions 44a and 47a and the tabs 44b and 47b into the gaps G1 and G2 in the vehicle width direction by elastically deforming in a direction away from the ends 33 and 37c in the up-down direction. Further, the elastic projections 35a and 39a respectively include the through-holes 35b and 39b, which extend therethrough in the up-down direction. The tabs 44b and 47b are engaged with the wall surfaces 35c and 39c of the through-holes 35b and 39b, with the contact portions 44a and 47a and the tabs 44b and 47b inserted into the gaps G1 and G2.

In such a configuration, elastic deformation of the elastic projections 35a and 39a causes the contact portions 44a and 47a and the tabs 44b and 47b to be inserted into the gaps G1 and G2, which are between the ends 33 and 37c and the elastic projections 35a and 39a, in the vehicle width direction. After the contact portions 44a and 47a and the tabs 44b and 47b are inserted into the gaps G1 and G2, the tabs 44b and 47b are engaged with the wall surfaces 35c and 39c of the through-holes 35b and 39b in the elastic projections 35a and 39a. This limits movement of the restricting portions 44 and 47 relative to the elastic projections 35a and 39a in the front-rear direction and on the outside in the vehicle width direction. Thus, with the above-described configuration, the elastic projections 35a and 39a having the through-holes 35b and 39b are positioned adjacent to the ends 33 and 37c with the gaps G1 and G2 in the up-down direction, thereby facilitating formation of the receiving portions 35 and 39.

(4) The box body 12A includes the storage defined by the body upper portion 20 and the support 31. Further, the box body 12A includes the second vertical wall 36, which protrudes downward from the coupling wall 32 as part of the bottom wall of the storage and extends in the front-rear direction, and multiple horizontal walls 37, which protrude outward from the second vertical wall 36 and extend in the front-rear direction. The side panel 40A covers the first side wall 23, the first vertical wall 34 of the support 31, and the second vertical wall 36 from outside. The coupling wall 32, the second vertical wall 36, the horizontal wall 37C, and the side panel 40A form the duct 50. The duct 50 includes the passages 51a and 52a, through which conditioned air supplied from the air-conditioning device flows.

With such a configuration, the side panel 40A is coupled to the box body 12A, so that the duct 50 having the passages 51a and 52a through which conditioned air flows is formed by the coupling wall 32, the second vertical wall 36, the horizontal wall 37C, and the side panel 40A. Thus, a duct function is imparted to the console box 12.

For example, if the receiving portions 35 and 39 and the tabs 44b and 47b of the restricting portions 44 and 47 are not provided, looseness of the side panel 40A may occur. In this case, when slight gaps are created between the ends 33, 37c and the restricting portions 44, 47, conditioned air may leak out of the gaps. Further, whistling noise may be generated from the gaps.

With the above-described configuration, in a state in which the ends 33 and 37c are in contact with the restricting portions 44 and 47 of the side panel 40A, the tabs 44b and 47b of the restricting portions 44 and 47 are engaged with the through-holes 35b and 39b of the receiving portions 35 and 39. Accordingly, as looseness of the side panel 40A is limited, the occurrence of the above gaps is also limited. This limits the degradation of the duct function of the console box 12 and limits the generation of whistling sound.

(5) The side panel 40A includes the upper side panel 41, the lower side panel 43, which is located inward of the upper side panel 41, and the connecting wall 42, which connects the two panels 41 and 43 to each other. The outer side panel 40B is coupled to the lower side panel 43 from outside. The console box 12 includes the outer anti-condensation portion 60 with the cavity 60a, which is defined by the connecting wall 42, the lower side panel 43, and the outer side panel 40B.

If the lower side panel 43 is located on the same plane as the upper side panel 41, for example, the following problem occurs. If the outer anti-condensation portion 60 is provided in the console box 12, a simple arrangement of the outer anti-condensation portion 60 on the outer side of the lower side panel 43 is likely to increase the size of the console box 12 in the vehicle width direction. With the above-described configuration, the lower side panel 43 is located inward of the upper side panel 41. Thus, even when the outer anti-condensation portion 60 is provided on the outer side of the lower side panel 43, the outer anti-condensation portion 60 is less likely to protrude outward from the upper side panel 41 in the vehicle width direction. This limits the increase in the size of the console box 12 in the vehicle width direction.

In particular, in the present embodiment, the outer surface of the outer side panel 40B is flush with the outer surface of the upper side panel 41. This prevents the aesthetic appeal of the console box 12 from being impaired by outward protrusion of the outer anti-condensation portion 60 beyond the upper side panel 41.

(6) The first restricting portion 44 includes the lower restricting portion 44B, which is formed by inwardly bulging the upper end of the connecting wall 42.

With this configuration, the lower restricting portion 44B of the first restricting portion 44, which comes into contact with the end 33 from below, is formed as part of the connecting wall 42. Thus, as compared with when, instead of the lower restricting portion 44B, for example, a lower restricting portion is formed as a protrusion that protrudes inward below the upper restricting portion 44A and comes into contact with the end 33 from below, the rigidity of the lower restricting portion 44B is increased.

### Modifications

The above-described embodiment may be modified as follows. The above-described embodiment and the following modifications can be combined as long as the combined modifications remain technically consistent with each other.

The console box 12 does not have to include the outer anti-condensation portion 60. In this case, the cover 40 does not have to include the outer side panel 40B.

The console box 12 does not have to include one of the two ducts 50.

The duct 50 does not have to include at least one of the horizontal walls 37A and 37B. In this case, the duct 50 does not have to include either the upper duct 51 or the lower duct 52, and does not have to include only the anti-condensation portion 53. Further, the duct 50 may include only one of the upper duct 51 and the lower duct 52.

In the side panel 40A, as illustrated in the present embodiment, the upper restricting portion 44A of the first restricting portion 44 and the lower restricting portion 47B of the third restricting portion 47 do not have to include the tabs 44b and 47b, respectively. The side panel 40A does not have to include a tab on one of the two restricting portions 44A and 47B. In this case, of the receiving portions 35 and 39, a receiving portion provided to correspond to the one of the restricting portions may be omitted from the box body 12A.

The receiving portion of the present disclosure does not have to include the through-hole 35b (39b), which extends therethrough in the up-down direction, as illustrated in the present embodiment. For example, instead of the through-hole 35b (39b), the receiving portion may include a recess that is provided in the elastic projection 35a (39a) and opens toward the end 33 (37c).

The receiving portion of the present disclosure is not limited to the receiving portion 35 (39) including the elastic projection 35a (39a) as illustrated in the present embodiment. For example, the receiving portion may be formed by providing a through-hole that extends through the end 33 (37c) in the up-down direction or a recess that opens toward the upper restricting portion 44A (lower restricting portion 47B). In this case, the upper restricting portion 44A (lower restricting portion 47B) may include, instead of the tab 44b (47b), a tab that protrudes from the contact portion 44a (47a) toward the end 33 (37c) in the up-down direction and engages with the through-hole or the recess.

The protruding wall of the present disclosure is not limited to the end 33 (37c) provided in the body lower portion 30 as illustrated in the present embodiment. Instead, a protruding wall may be newly provided in the body upper portion 20. In this case, for example, at least one of the reinforcing ribs 26 may be used as the protruding wall of the present disclosure.

The restricting portion newly provided in the upper side panel 41 in the above modification does not have to be configured such that one of the upper restricting portion and the lower restricting portion is formed by a protrusion continuously extending in the front-rear direction as in the restricting portion 44 or 47 illustrated in the present embodiment. That is, the restricting portion may be configured such that multiple upper restricting portions and multiple lower restricting portions are spaced apart from one another in the front-rear direction.

The restricting portion newly provided in the upper side panel 41 in the above modification does not have to be configured such that the upper restricting portions and the lower restricting portions are arranged in the up-down direction. For example, the restricting portion may be configured such that multiple upper restricting portions and multiple lower restricting portions are alternately arranged at intervals in the front-rear direction.

The box body 12A does not have to include the duct 50 as illustrated in the present embodiment. For example, the body lower portion 30 may be omitted from the box body 12A, so that the box body 12A includes only the body upper portion 20.

In the present embodiment, the protruding wall with a thickness in the up-down direction is illustrated as the protruding wall. However, the thickness direction of the protruding wall of the present disclosure may be changed. For example, when the protruding wall has a thickness in the front-rear direction, the front-rear direction of the vehicle 10 corresponds to the thickness direction, and the up-down direction of the vehicle 10 corresponds to the intersecting direction. In accordance with the above change, the shapes and arrangement of the receiving portions and the restricting portions may be changed.

The protruding wall of the present disclosure does not have to be provided on the box body 12A as illustrated in the present embodiment. Similarly, the restricting portion of the present disclosure does not have to be provided on the side panel 40A. For example, the side panel 40A may include a protruding wall that protrudes inward, and the box body 12A may include a restricting portion that restricts relative movement of the protruding wall in the up-down direction.

The cover of the present disclosure is not limited to the side panel 40A as illustrated in the present embodiment, and may be, for example, a rear surface cover that covers the rear surface of the box body 12A.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A console box, comprising:
a box body; and
a cover coupled to the box body to cover part of the box body from outside, wherein
one of the box body and the cover includes a protruding wall that protrudes toward an other one of the box body and the cover,
the other one of the box body and the cover includes a restricting portion that restricts relative movement of the protruding wall in a thickness direction of the protruding wall by coming into contact with the protruding wall from opposite sides of the protruding wall in the thickness direction,
the restricting portion includes:
a contact portion that protrudes toward the one of the box body and the cover and comes into contact with the protruding wall; and
a tab that protrudes from the contact portion toward one side in the thickness direction, the tab engaging with a receiving portion in a state in which the protruding wall is in contact with the restricting portion, and the receiving portion being located on the one of the box body and the cover, and
the receiving portion is configured to restrict relative movement of the restricting portion in a protruding direction of the protruding wall and an intersecting direction when the tab engages with the receiving portion, the intersecting direction intersecting the thickness direction and the protruding direction.

2. The console box according to claim 1, wherein
the receiving portion includes an elastic projection that protrudes toward the other one of the box body and the cover at a position adjacent to the protruding wall with a gap in the thickness direction, the elastic projection being configured to allow insertion of the contact portion and the tab into the gap in the protruding direction by elastically deforming in a direction away from the protruding wall in the thickness direction,
the elastic projection further includes a through-hole or a recess, the through-hole extending through the elastic projection in the thickness direction, and the recess opening toward the protruding wall in the thickness direction, and
the tab is engaged with a wall surface of the through-hole or the recess in a state in which the contact portion and the tab are inserted into the gap.

3. The console box according to claim 1, wherein
the intersecting direction, the protruding direction, and the thickness direction are defined as a front-rear direction of a vehicle, a vehicle width direction, and an up-down direction, respectively, and a side away from a central portion of the box body in the vehicle width direction is defined as an outer side,
the box body includes:
a storage opening upward and configured to accommodate an article;
a vertical wall protruding downward from a bottom wall of the storage and extending in the front-rear direction; and
a horizontal wall protruding outward from the vertical wall and extending in the front-rear direction,
the cover covers part of the storage and the vertical wall from outside,
the bottom wall, the vertical wall, the horizontal wall, and the cover form a duct, the duct including a passage through which conditioned air supplied from an air conditioner flows, and
at least one of an outer end of the bottom wall and an outer end of the horizontal wall is the protruding wall.
